(19) United States
(12) Patent Application Publication
(10) Pub. No.: US 2006/0206171 A1
(43) Pub. Date: Sep. 14, 2006

(54) Devices, methods and kits for radiation treatment via a target body surface

(76) Inventors: Michael Gertner, Menlo Park, CA (US); Erica Rogers, Redwood City, CA (US)

Correspondence Address: WILSON SONSINI GOODRICH & ROSATI, 650 PAGE MILL ROAD, PALO ALTO, CA, 94304-1050, US

(21) Appl. No.: 11/244,812

(22) Filed: Oct. 5, 2005

Related U.S. Application Data
(63) Continuation-in-part of application No. 11/152,946, filed on Jun. 14, 2005.
(60) Provisional application No. 60/661,688, filed on Mar. 14, 2005.
(60) Provisional application No. 60/690,792, filed on Jun. 15, 2005.

(51) Int. Cl. A61H 33/00; A61H 21/00

(52) U.S. Cl. 607/86

(57) ABSTRACT

A method and apparatus is described for treating a target body surface using a radiation applicator. The radiation applicator includes a radiation source in combination with a delivery applicator. The applicator has a low profile enable the patient to apply the applicator to a target area underneath, for example, clothing. The applicator can be configured to use one or more radiation sources to apply one or more types of radiation for one or more periods of time. Additionally, the applicator can be configured with a feedback loop to determine when a therapeutically desirable amount of radiation has been delivered.

### CROSS-REFERENCE

This application claims the benefit of U.S. Provisional Application No. 60/690,792, filed Jun. 15, 2005, which is incorporated herein by reference in its entirety.

This application is also a continuation-in-part application of Ser. No. 11/152,946, filed Jun. 14, 2005, which claims benefit of U.S. Provisional Application No. 60/661,688 filed Mar. 14, 2005, which is also incorporated herein by reference in its entirety and to which application we claim priority under 35 USC §120.

### BACKGROUND OF THE INVENTION

1. Field of the Invention

The invention relates to devices and methods for delivering radiation to target body surfaces, including dermatologic treatment methods and apparatuses. The field includes methods and apparatuses for treating skin, including psoriasis, atopic dermatitis, contact dermatitis, vitiligo, seborrheic dermatosis and skin cancer.

2. Background of the Invention

The therapeutic use of light has been shown to be effective in the treatment of various medical conditions. For example, whole body exposure to ultraviolet (“UV”) light has been used for medical applications, such as the treatment of psoriasis and vitiligo. Ultraviolet lasers and lamps have also been designed to illuminate more localized regions of the skin for treatment of lesions and marks.

It is estimated that 5 million adults in the U.S. suffer from psoriasis. Psoriasis is broken into five categories: plaque, guttate, inverse, pustular, and erythrodermic. Psoriasis can occur at a variety of locations, including hands, feet, scalp, etc. For example, plaque psoriasis, the most common form, is characterized by raised, inflamed, red lesions covered by a silvery white scale. It is typically found on the elbows, knees, scalp and lower back, although it can occur on any area of the skin. The guttate form of psoriasis resembles small, red, individual spots on the skin. Guttate lesions usually appear on the trunk and limbs. These spots are not normally as thick or as crusty as lesions of plaque psoriasis.

Vitiligo is a pigmentation disorder in which melanocytes (the pigment making cells in the skin), the mucous membranes, and the retina are destroyed. As a result, white patches of skin appear on different parts of the body. It is estimated that 1-2% of the world's population (40-50 million people) have vitiligo, 2-5 million of whom are located in the United States.

Atopic dermatitis, more commonly referred to as eczema, is a chronic (long-lasting) disease that affects the skin. In atopic dermatitis, the skin becomes extremely itchy. Scratching leads to redness, swelling, cracking, “weeping” clear fluid, and finally, crusting and scaling. It is estimated that 5 million Americans under the age of 65 have atopic dermatitis. Seborrheic dermatitis is a chronic form of dermatitis characterized by oily scales, crusty yellow patches, and itching that occurs primarily on the scalp and face. Contact dermatitis is a disorder which can be allergic or non-allergic in nature but is almost always immune mediated and affects several million people in the United States alone. It is considered a major cause of occupational disability and leads to billions of dollars in health care expenditures.

It is estimated that more than 1 million people are diagnosed with skin cancer each year; and 1 in 5 Americans will have an incident of skin cancer in their lifetime. Skin cancers are categorized as: melanoma, basal cell carcinoma, squamous cell carcinoma, and actinic keratosis, Melanoma is the most serious form of skin cancer, but if treated early can be cured. Basal cell carcinoma is the most common type of skin cancer. Skin cancer can be treated by, among other things, radiation therapy.

A variety of devices are known for delivering light and/or radiation. For example, PCT Publication WO 2005/000389 describes a tanning and light therapy device (see also, U.S. Patent Pub. 2004/0232339). U.S. Pat. No. 6,290,713 describes a flexible illuminator for phototherapy; U.S. Patent Pub. 2004/0176824 describes a method and apparatus for the repigmentation of human skin; U.S. Pat. No. 6,730,113 describes a method and apparatus for sterilizing or disinfecting a region through a bandage; U.S. Pat. No. 6,096,066 describes a conformal patch for administering light therapy to subcutnaeous tumors; and U.S. Pat. No. 6,645,230 describes a therapeutic light source and method. A variety of devices are also known for providing bandages or dressing, including, for example, U.S. Pat. Nos. 2,992,644; 3,416,525; 3,927,669; 4,126,130; 4,561,435; 4,616,644; 4,671,266; 4,901,714; 5,336,209; 5,954,679; 6,343,604 B1; 6,384,294 B1; and U.S. Patent Publications US 2001/0029943 A1; US 2002/0128580 A1; US 2002/0183813 A1; US 2003/0199800 A1; US 2003/0164074 A1; US 2003/0143264 A1; US 2004/0087884 A1; US 2004/0049144 A1; and US 2005/0010154 A1.

### SUMMARY OF THE INVENTION

The invention relates to a photodynamic or radiation treatment apparatus having a plurality of light and/or radiation source(s) adapted to irradiate a target portion of a body.

An embodiment of the invention includes a photodynamic treatment apparatus comprising: a plurality of light sources adapted to emit light at a peak wavelength between about 300 nm and about 320 nm; a light source support structure adapted to be worn by a patient and to support the light sources in a manner permitting light from the light sources to reach a skin area of the patient; a controller adapted to operate the light sources; and a power supply adapted to provide power to the light sources.

Another embodiment of the invention includes a radiation treatment device adapted to delivery radiation therapy to a target body surface comprising: a substrate adapted to contact a target surface of a human body; a first radiation source for delivering radiation to the target surface area of the human body and adapted to engage the substrate; and a controller integrated with the substrate and adapted to control at least one of duration or amount of radiation delivered by the radiation source.

The radiation applicator may include one or more radiation source(s) coupled to a substrate (e.g., a layer, such as a fabric strip on which radiation source(s) are positioned for presentation of radiation to a target body surface). In one embodiment, a controller and a power source are also coupled to a substrate. In another embodiment, the size of the controller and the power source are such that the radiation applicator is portable and comfortable to wear without, for example, being held in the hand of a patient. In an embodiment, the radiation applicator is self-contained and does not need to be attached to any external, non-portable, device to operate.

In yet another embodiment, the substrate (supporting the radiation source(s)) is flexible. In an embodiment, the radiation applicator is worn like a bandage and the radiation source(s) are located in and/or on a region of the substrate that is smaller than the entire substrate (analogous in structure to the gauze pad of a Bandaid® type bandage, for example). Further, the substrate can include an adhesive section to conformably retain the radiation applicator to the target body surface. In yet another embodiment, the size of the region containing the radiation source(s) is based on an expected size of a typical disorder being treated, while, in contrast, the size of the entire substrate is based on the minimum size that is large enough to ensure that the radiation applicator is securely attached to the body being treated.

Instill other embodiments, any of the radiation source(s) can be turned on and off such that at any one time the number of radiation source(s) that is on is less than the entire number of radiation source(s) presented on the substrate. In an embodiment, the duty cycle used and the number of radiation source(s) that are on at any one time are based on the power capabilities of the power source. In an embodiment, the duty cycle and number of radiation source(s) that are on are based on cooling requirements of the radiation source(s), a prescribed treatment, and/or a temperature range that the patient is expected to find comfortable. In another embodiment, some of the radiation source(s) are not turned on at all as programmed by the patient or medical practitioner to provide a desired sequence of operations because, for example, the area of required treatment of the body is smaller than the area of the radiation source(s). The radiation applicator may also have a calibration mode for calibrating the radiation dose to a specific body and/or patient, or to provide a change in radiation intensity along the substrate.

In yet another embodiment of the invention a method of providing light therapy to a skin area of a patient comprising: attaching a plurality of light sources to the skin area; providing power to the light sources from a power supply worn by the patient; and providing light having a peak wavelength between about 300 nm and about 320 nm from one or more of the light sources to the skin area is provided. Embodiments of the method can include providing light therapy to a skin area of a patient of claim 36 wherein the step of providing light comprises providing light having a peak wavelength between about 308 nm and about 312 nm from one or more of the light sources to the skin area. In other embodiments of the method light therapy is provided to a skin area of a patient from first and second sets of one or more light sources, step of providing light comprises providing light from the first set of light sources and not from the second set of light sources and providing light from the second set of light sources and not from the first set. Additional methods can include providing light from the first set of light sources comprises supplying an energy dose of between about 100 mJ/cm² and about 600 mJ/cm² from the first set of light sources. While performing these methods, the duration of providing light can also be monitored. Additionally, the light source can be calibrated to provide a therapeutic dose of energy.

In yet another embodiment of the invention a method of calibrating a target surface area of a human body comprising: applying a radiation treatment device to the target area of the human body; monitoring an irradiation of the target surface area of the human body; assessing whether erythema is present; and setting a minimum erythemal dosage for the radiation treatment device is provided.

In yet another embodiment of the invention, a method of calibrating a target surface area of a human body comprising: applying a radiation treatment device to the target area of the human body; monitoring a condition of the target surface area of the human body; assessing whether erythema is present; and setting a minimum erythemal dosage for the radiation treatment device is provided.

In still another embodiment of the invention, a method of treating a target surface area of a human body comprising: applying a radiation treatment device to the target area of the human body; and monitoring the irradiation of the target surface area of the human body is provided.

A kit for treating a target area of a human body needing therapy is also provided. The kit comprising: a first radiation treatment device having a substrate adapted to contact a target surface of a human body, a radiation source for delivering radiation to the target surface area of the human body and adapted to engage the substrate, and a controller adapted to control at least one of duration or amount of radiation delivered by the radiation source; and a second radiation treatment device having a substrate adapted to contact a target surface of a human body, a radiation source for delivering radiation to the target surface area of the human body and adapted to engage the substrate, and a controller adapted to control at least one of duration or amount of radiation delivered by the radiation source.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates an example of a radiation applicator for applying radiation to a target surface;

FIG. 2A illustrates an example of target surface of a body being treated using the radiation applicator of FIG. 1; FIG. 2B illustrates a cross-sectional view of a target surface of a body being treated using the radiation applicator of FIG. 1;

FIG. 3 illustrates a block diagram of an example of the radiation applicator of FIG. 1;

FIG. 5A shows a block diagram of an example of a radiation source used in FIGS. 1-3; FIG. 5B illustrates a cross-section of a radiation applicator of FIG. 3; FIG. 5C illustrates another example of a radiation source of FIG. 1;

FIG. 6A illustrates yet another example of a radiation applicator; FIG. 6B illustrates an example of a cross-section of the radiation applicator of FIG. 6A;

FIG. 7 illustrates a flowchart of an a method of calibrating the radiation applicator for a particular patient;

FIG. 8 illustrates a flowchart of an example of a method of using the radiation applicator; and

FIG. 9 illustrates a flowchart of an example of a method of assembling the radiation applicator.

### DETAILED DESCRIPTION OF THE INVENTION

A radiation applicator used for irradiating a target portion of a body for medical treatment is disclosed. In an embodiment, radiation delivered by a radiation applicator is ultraviolet light. In other embodiments, other forms of radiation may be delivered by the radiation applicator.

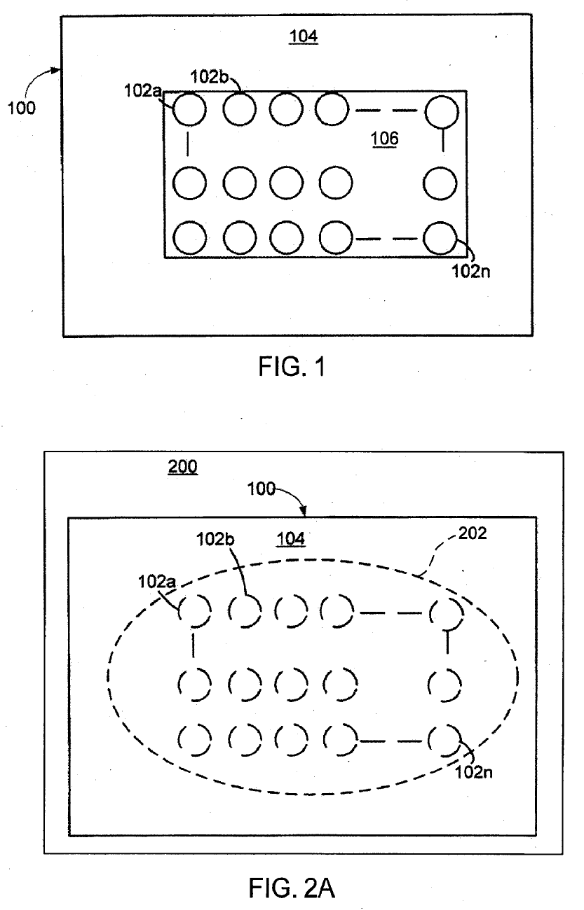

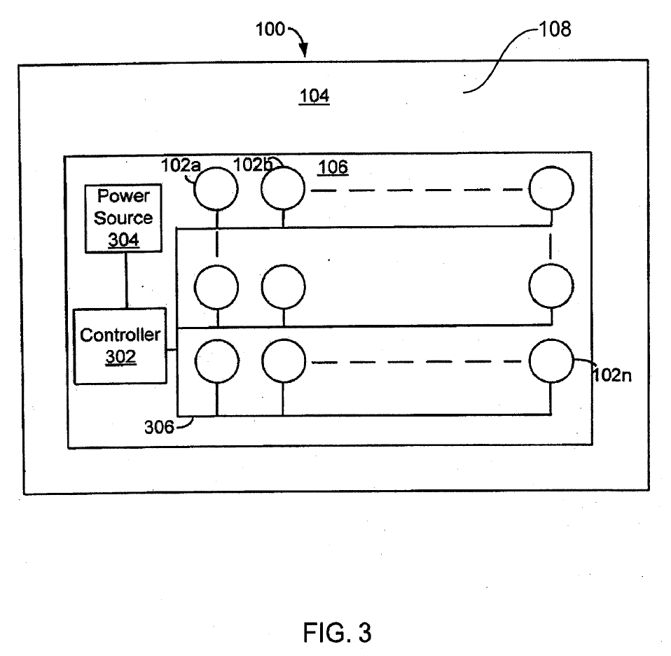

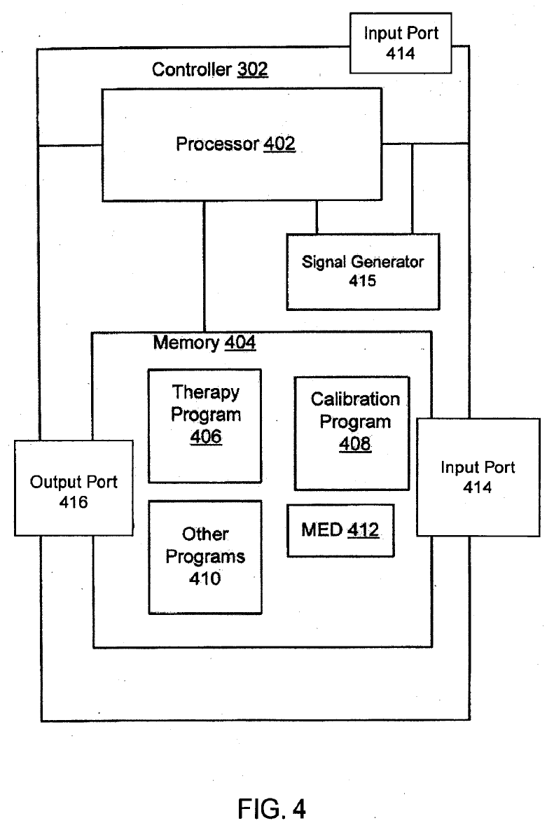

FIG. 1 shows a radiation applicator 100 for treating a target surface of a body with radiation. The radiation applicator 100 has at least a first side and a second side, or a top side and a bottom side. The target surface is typically an exposed portion or surface, e.g. of skin, where it is desirable to apply radiation. Radiation applicator 100 may include one or more radiation source(s) 102 (e.g. 102a-102n) each of which has at least a first side and a second side, and substrate 104, also having a first side and a second side, which can be in the form of a layer or material on which the electrodes are formed or fabricated. In a preferred embodiment a plurality of radiation sources 102 are provided. In further embodiments, the radiation applicator 100 has a region 106 that has a surface area smaller than the surface area of the subs rate 104 (as illustrated in FIG. 3). As will be appreciated by those skilled in the art, radiation applicator 100 need not have all of the components depicted in FIG. 1 and/or may include other components, in addition to or instead of those depicted with FIG. 1. For purposes of illustration, the geometric profile of the radiation applicator 100 has been shown as having a rectangular profile (e.g. a length greater than a width). As will be appreciated by those skilled in the art, other profiles can be employed, either geometric or non-geometric (e.g., random) without departing from the scope of the invention. The various layers and elements of the applicator 100 can be configured such that each provides a surface-to-surface contact with an adjacent element.

Radiation source(s) 102 may produce any of a variety of types of radiation, such as UV light, that are used for treating disorders, ailments or diseases by irradiating a target portion of the body, such as an exposed surface of skin. A variety of dermatologic disorders, such as psoriasis, contact dermatitis, atopic dermatitis, vitiligo, seborrheic dermatosis, and skin cancer, may be treated with UV light, as discussed above. For example, when treating psoriasis, radiation source(s) 102 may emit light having a wavelength in the range of 295-320 nm, 300-305 nm, 308-315 nm, or a combination of these wavelengths in one or more peaks. Additionally, there may be any number of radiation source(s) 102 with any combination of wavelengths.

It may be desirable to provide radiation source(s) that are capable of delivering more than one type of radiation. For example, atopic dermatitis can be treated with a device using, for example, a combination of UVB and UVA, wavelengths. Thus, Alternatively, it may be desirable to provide radiation source(s) 102 within the substrate 104 that can deliver a first radiation type or wavelength in combination with radiation source(s) 102 that can deliver a second, or subsequent, radiation type or value that is different from the first radiation type or wavelength. As will be appreciated by those of skill in the art, additional wavelengths or sources of radiation can be included without departing from the scope of the invention, and thus the invention is not limited to delivery of two radiation types.

Infectious disorders can also be treated with the radiation source(s). For example, where infectious disorders are treated, shorter wavelengths, including those having a wavelength of 254-270 nm or 270-295 nm, have been shown to be beneficial. As will be appreciated, the various dashed lines between various ones of radiation source(s) 102 (e.g. 102a-102n) indicate that there may be any number of radiation source(s) in that location spanning the region of the dashed lines and the region between the dashed lines, as necessary or desirable.

In another embodiment, radiation source(s) 102 (e.g. 102a-102n) produce infrared light, microwaves, radio frequency radiation, and/or other wavelengths of light, for example, or combinations thereof. Heat (infrared light) sometimes promotes healing of sprains and muscle injuries, and additionally may produce a feeling of well-being, even if no actual healing occurs. Infrared wavelengths include wavelengths from 780 nm to 10 microns. Infrared light can also be used to aid in healing of open surface wounds on a body or to increase the blood flow to a body surface. In some embodiments, the infrared light can be used to increase local blood flow to a body surface in order to improve the efficacy of phototherapy or photodynamic therapy. Some wavelengths of light (e.g. those having a wavelength of 450-460 nm) may be effective in treating different disorders, such as for lowering the bilirubin count in babies. In one embodiment, radiation source(s) 102 are used for treating disorders on a surface of a body. In another embodiment, radiation source(s) 102 emit forms of radiation (e.g., wavelengths of light) that penetrate below the surface of the body, and radiation source(s) 102 are used for treating disorders below the surface of the body. In some embodiments, photodynamic therapy is initiated with radiation source(s) 102. Photodynamic therapy includes a light source (e.g. device 100) and a photosensitizer which can be administered systemically or injected into a lesion or placed in close proximity to the lesion.

In one embodiment, all radiation source(s) 102 produce the same peak wavelength and/or spectrum of radiation when activated. In another embodiment, different ones of radiation source(s) 102 produce different spectrums of radiation and/or have different peak wavelengths. In an embodiment, whether or not all radiation source(s) 102 are the same or some are different from others, the spectrum of radiation produced may be controllable (e.g., by adjusting the current) so that the wavelength or combination of wavelengths of light may be adjusted according to the type of disorder being treated. In some embodiments where an optical disperser is used, a multiplicity of radiation source(s) can be combined into a predetermined spectral output. In these embodiments, the spectrum can be tailored by turning one or more of the radiation sources on or off at different times.

Radiation source(s) 102 may require a power source. Embodiments including a power source are discussed in conjunction with FIGS. 3, 5C, and 6A, for example. Alternatively, some radiation source(s) 102 may not require a power source. For example, radiation source(s) 102 may produce light via fluorescence or chemical luminescence. In another embodiment, radiation source(s) 102 can be powered by photovoltaic cells. Alternatively, radiation source(s) 102 may include a radioactive material that emits alpha, beta, and/or gamma particles. For example, radiation source(s) 102 may be discs of P-32, In 111, radioactive isotopes, cesium 137 and/or another radioactive material, which may be useful for treating certain types of cancer.

Substrate 104 may take many forms. Substrate 104 may be any suitable material such as a piece of material, which in turn may be a strip of fabric. Substrate 104 may be solid, a mesh, or netting, for example. Substrate 104 may be a flexible material that can be wrapped around a limb or placed on another body part. In one embodiment, substrate 104 is a bandage. For example, substrate 104 may have an adhesive layer on at least a portion of one surface of the substrate such as the surface that contacts the target body surface. Alternatively, substrate 104 does not have an adhesive layer. In another embodiment, substrate 104 may be an article of clothing, such as a sock, a glove, a sweater, a ski mask, an arm band, a leg band, etc. In some embodiments, the substrate 104 is patient compatible. If substrate 104 is not patient compatible, then the substrate can be furthered covered with a patient compatible material.

In another embodiment, instead of being flexible, substrate 104 is rigid and is held onto the portion of the body being treated by being attached to a bandage or by being wrapped within a bandage. Whether substrate 104 is rigid or flexible, a separate substrate, such as a stocking, a glove, or a circumferential cloth, may be utilized to hold the substrate 104 onto a target portion of a body.

Substrate 104 may be opaque, transparent, translucent, reflective, or made from a light scattering material. Radiation source(s) 102 (e.g. 102a-102n) may be located on substrate 104. For example, radiation source(s) 102 may be attached to a surface of substrate 104 and/or formed integrally within substrate 104 (e.g., embedded or formed within the substrate to provide a complete, unified radiation applicator 100). Alternatively, one portion of the radiation source can be attached on the outside of the material (e.g. the side of the material not facing the lesion or target body surface) and the other side of the radiation source (e.g. the light emitting side) is attached on the inside of the substrate (e.g. the side of the material facing the lesion). In this embodiment, the housing of the radiation source traverses the substrate 104 and the power is supplied along the surface of the substrate 104 facing away from the region of the body with the lesion. Substrate 104 may be of a size and/or shape that facilitates securely attaching radiation applicator 100 to a body. In an embodiment, radiation applicator 100 can be worn by a patient without any external attachments. In an embodiment, radiation applicator 100 may be self-contained. Making radiation applicator 100 self-contained and/or wearable without any external attachments (e.g., in the form of an adhesive bandage) facilitates making radiation applicator 100 portable. A portable applicator which can be worn by a patient under other clothes or while he or she is performing other tasks or while sleeping may have many advantages in terms of, for example, the quality of life of the patient and in terms of compliance.

Region 106 is a region of substrate 104 within which radiation source(s) 102 (E.g. 102a-102n) are located. Region 106 can have a surface area that is less than the surface area of substrate 104. Substrate region 106 may be of a size and/or shape that is expected to cover all of, or a substantial part of, a portion (of a body) affected by a typical occurrence of a particular type of disorder (such as a lesion). Alternatively, region 106 may be of a size and/or shape that is expected to be smaller than the portion of the body affected by a typical occurrence of a particular type of disorder. In one embodiment, substrate region 106 is defined only by the location of radiation source(s) 102, but is otherwise structurally identical to the rest of substrate 104. In another embodiment, region 106 may have one or more structural features that distinguish region 106 from the rest of substrate 104. In one example, substrate 104 is rectangular in shape, optionally having rounded corners, and region 106 is located in a central portion of substrate 104 that extends nearly the entire width of substrate 104, but only extends less than one third or less than one quarter of the length of the substrate 104. In a further embodiment of this example, substrate 104 is flexible and has an adhesive in the portions 108 outside of the region 106 for adhering to a body being treated, but no adhesive is inside of region 106. Region 106 may be analogous in structure to the gauze pad of a Bandaid® type bandage. In this example, region 106 and substrate 104 are of a similar size as the gauze pad region of a bandage for covering a cut or scrape. For example, region 106 may include a gauze pad, and any one of, any combination of, or all of radiation source(s) 102, controller 302 (discussed below), and/or power source 304 may be located on, behind, and/or embedded within the gauze pad.

Substrate region 106 may include a protective layer for radiation source(s) 102 that is not present in the remainder of substrate 104. Within region 106, substrate 104 may have additional elements or features, such as structural features, that promote cooling, or condition the spectral output of radiation source(s) 102. These elements and features include, but are not limited to, selectively providing perforations (not shown) that penetrate all or a portion of the radiation applicator 100 on at least a portion of the applicator. In yet another embodiment, region 106 may be a piece of removable material that supports radiation source(s) 102. Having a removable substrate region 106 allows the same substrate 104 to be used with a multiplicity of different sets of radiation source(s) 102 in which each set is designed for treating a different disorder or set of disorders. In another embodiment, a material covers region 106. This material is a disposable material which is transparent to the radiation from radiation source(s) 102 and is discarded after the therapy, allowing the devices in region 106 to be reusable without concern for the devices being soiled. In another embodiment, substrate region 106 may be absent, and radiation source(s) 102 may be uniformly distributed throughout substrate 104.

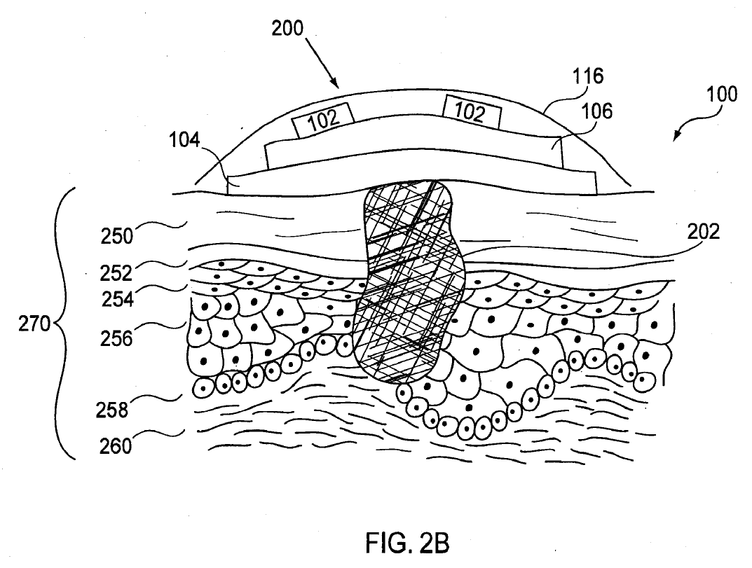

FIG. 2A shows an example of a portion of a body 200, e.g. a target portion of a human body, such as a skin layer, while being treated. During treatment of body portion 200, radiation applicator 100 is placed on a lesion 202 on body portion 200. Lesion 202 is any patch of unhealthy tissue surface that is expected to be at least partially treatable by irradiating with radiation, such as light. (Lesion 202 is illustrated with a dashed line in FIG. 2A because lesion 202 is under radiation applicator 100 and specifically under region 106.) Body portion 200 is any target surface of a body, e.g., external, or externally exposed, portion of the body such as skin. For example, portion 200 may be a portion of skin on a limb (e.g., the arm), or the hand of a patient. In the embodiment of FIG. 2A, substrate 104 is a single opaque layer, and radiation source(s) 102 (e.g. 102a-102n) are placed on one side of substrate 104. Consequently, radiation source(s) 102 (e.g. 102a-102n) are drawn with dashed lines to indicate that radiation source(s) 102 are between substrate 104 and lesion 202, so as to irradiate lesion 202 without being impeded by substrate 104. Similar to FIG. 1, the various dashed lines between radiation source(s) 102 indicate that there may be any number of radiation source(s) in that location spanning the region of the dashed lines and between the dashed lines. Although FIG. 2A illustrates an embodiment in which substrate 104 is a single opaque strip, any of the other embodiments of radiation applicator 100 may be used instead.

If substrate 104 is transparent or translucent, then substrate 104 could be placed between radiation source(s) 102 and lesion 202. An advantage to placing substrate 104 between radiation source(s) 102 and lesion 202 is that radiation source(s) 102 may be left exposed to air, which may facilitate passive and/or active (e.g. a thermoelectric cooling device) cooling of radiation source(s) 102. Alternatively, the devices 102 may be adapted to traverse the material so that the light emitting face is placed between the substrate 104 and lesion 202 and the electrical connections and heat generating components direct heat away from the lesion 202, through the substrate 104 and then to the ambient atmosphere. Also, substrate 104 may include elements and/or structural features that facilitate uniform irradiation of lesion 202, such as by scattering or focusing the radiation emitted from radiation source(s) 102. One example of a scattering structure is a substrate having one or both of its outer surface and its surface facing radiation source(s) 102 roughened or textured. Another example of a scattering structure is a substrate having particles (e.g., titanium oxide and/or aluminum oxide) embedded within it that have a different index of refraction than the substrate. Any one of, any combination of, or all of these scattering structures may be included in substrate 104 (and/or within other layers) for uniformly irradiating lesion 202.

An advantage in placing radiation source(s) 102 between substrate 104 and lesion 202 is that a greater percentage of the radiation generated is incident upon lesion 202. Consequently, the power efficiency may be greater without substrate 104 intervening between radiation source(s) 102 and lesion 202 than with substrate 104 in an intervening position.

FIG. 2B illustrates a target body surface, such as a layer of skin 270. The layer of skin is comprised of the stratum corneum 250, the stratum lucidum 252, the stratum granulosum 254, the germitive layer 256, 258 and the dermis 260. Lesion 202 is depicted crossing all of the layers for purposes of illustration. However, as will be appreciated by those skilled in the art, the layers of the skin affected by the lesion will be determined by the type and extent of medical condition associated with the skin, e.g. psoriasis, contact dermatitis, vitiligo, atopic dermatitis, and skin cancer. In this illustration, the radiation applicator 100 is positioned on the target body surface to be treated such that the radiation source(s) 102 will be in proximity to the lesion 202.

FIG. 3 shows a block diagram of an example of radiation applicator 100. Similar to FIG. 1, FIG. 3 shows radiation source(s) 102 (e.g. 102a-102n), substrate 104, and region 106. Additionally, FIG. 3 shows controller 302, power source 304, and electrical connectors 306. In other embodiments, radiation applicator 100 may not have all of the components associated with FIG. 3 and/or may have other components in addition to, or instead of, those depicted for purposes of illustration with FIG. 3.

Radiation source(s) 102, substrate 104, and region 106 were described in conjunction with FIGS. 1 and 2A-B. Controller 302 may include a processor and/or a specialized circuit for controlling radiation source(s) 102. Controller 302 may be a microcontroller. For example, controller 302 may have a width and/or length that are less than 5 cm, less than 4 cm, less than 3 cm, less than 2 cm, or less than 1 cm. Controller 302 controls radiation source(s) 102 and may control how long and/or which ones of radiation source(s) 102 are on. Additionally, or alternatively, controller 302 may control the wavelength, frequency, and/or intensity of radiation of radiation source(s) 102. In addition, controller 302 can integrate feedback from reflectance sensors (not shown) associated with the device 100 which relay real-time information about the state of the lesion or of the surrounding skin.

In an embodiment, controller 302 may relieve the patient and/or doctor from the task of keeping track of the time that the therapy has been applied. For example, controller 302 may track the total amount of time that each individual one of radiation source(s) 102 and/or each of a plurality of groups of radiations source(s) 102 has been in use. In other words, each of radiation source(s) 102 may be turned on and off in cycles, and controller 302 or a timer (not shown) may keep track of the total amount of time and/or total energy that any given radiation source(s) has been kept on. The controller in some embodiments is critical to the portability of the device because the dosage being applied to the patient is not being monitored by the physician or patient and therefore it is possible that too high a dose is delivered to the treatment area, Since various groups of radiation source(s) 102 may be turned on and off together, keeping track of how long an individual radiation source has been on may be performed by keeping track of how long the group of radiation source(s) associated with this individual radiation source has been on, (because the group of radiation source(s) and any individual radiation source within the group is expected to have been on for the same amount of time).

When a particular one of, or group of, radiation source(s) 102 has delivered a predetermined therapeutic dose of energy, radiation controller 302 turns off the one of, or group of, radiation source(s) 102. A therapeutic dose of radiation may be an amount of radiation that has been determined to be the maximum or slightly less than the maximum tolerable dose during a particular treatment session. Tolerable can mean a sunburn in the case of ultraviolet light applied to the skin. Alternatively, a therapeutic dose of radiation may be an amount of radiation that has been determined to be appropriate for a particular disorder or a particular treatment session. As will be appreciated by those skilled in the art, different disorders may have different therapeutic doses. For example, a therapeutic dose may be a sub-threshold Minimal Erythemal Dose (MED). As another example, a therapeutic dose may be reached when all the radiation source(s) 102 or when all of the groups of radiation source(s) 102 have delivered 100-600 mJ/cm² (of ultraviolet light in the 295-320 nm range for example) to body portion 200. Consequently, when all of the groups of radiation source(s) 102 have delivered 100-600 mJ/cm² to portion 200, the therapy for that region is finished. In some embodiments, doses are applied to the treatment region on a continuous basis and the maximum therapeutic dose guides the therapy. For example, a time can be defined over which, a maximal dose cannot be exceeded. Using the skin as an example, an MED, a fraction of an MED, or a multiple of an MED can be given to a body region over a 30 second period, 12 hour period, over a 24 hour period, over a 48 hour period, or over any period of time in between or other time chosen by the patient or the physician; it is also the conceivable that erythema (in the skin for example) can be avoided altogether when the dose is given over a long period of time. After this period of time, another dose is give to the same region or another region.

In an embodiment, radiation applicator 100 may be programmed by the patient or by the physician to deliver a particular therapy over a period of time. In an embodiment, controller 302 may be programmed to calibrate radiation applicator 100 or have a calibration mode during which radiation applicator 100 is calibrated. For example, radiation applicator 100 may be calibrated for the patient prior to applying a therapy (e.g. due to the fact that different patients have different sensitivities to light due to differing amounts of melanin contained in a patient's skin).

During calibration, radiation applicator 100 is placed on a portion of the body that is unaffected by the disorder that portion 202 is affected by. For example, radiation applicator 100 is placed on a portion of healthy skin typically unexposed to sunlight (e.g., the gluteal region). Next, escalating doses of radiation are applied to the skin. The dose, which after 24 hours produces a superficial redness of the skin from dilation of the capillaries, or erythema, is called the Minimal Erythemal Dose (MED). Controller 302 may be programmed to automatically apply the escalating doses to different regions under radiation applicator 100. After 24 hours, the MED is determined by the region which has a perceptible erythema, or redness. The patient's MED is then programmed into controller 302 and the MED, or an amount of radiation slightly less than the MED, becomes the calibrating dose for the particular patient.

To treat a disease such as psoriasis, doses are typically related to the MED. For example, a standard course of therapy consists of 3 weeks of treatments, 3 times per week, with each treatment consisting of 1-3 MED depending on what the patient can tolerate. It is difficult, if not impossible, for the treatment area to be well-controlled; some areas of non-diseased skin will receive treatment. It is these areas which limit the amount of radiation which the affected areas can receive. Further, the risk of skin cancer is increased in the areas unaffected by disease but which are nonetheless exposed to radiation because of the non-specificity of the radiation applicator. Furthermore, the treatments are given three times per week solely because the unaffected skin must heal before the next treatment. A device which could limit treatment area to the lesional area could be beneficial in that the treatment dose and/or frequency could be increased and the total treatment time decreased. Furthermore, a device which does not require the patient to be at the physician's office or otherwise schedule time for a treatment could be highly beneficial in many patients and result in greater treatment protocol compliance by the patient which in turn would lead to greater efficacy of patient treatment. With radiation applicator 100, the treatment region can be finely tuned by the patient and/or physician. In embodiments where the device is worn, the patients do not have to stop what they are doing (e.g. work, sleep, exercise, etc.) to receive treatments.

In embodiments in which controller 302 is kept small (e.g., in embodiments in which controller 302 is a microcontroller), the small size facilitates making radiation applicator 100 portable. Controller 304 may be located on substrate 104. In an embodiment, controller 302 is an integral part of substrate 104 (e.g., controller 302 may be embedded within substrate 104). Controller 302 switches power between different radiation source(s) 102, so that some of radiation source(s) 102 are powered on while others are powered off. In an embodiment, controller 302 may never, or only infrequently, power on all of radiations sources 102 simultaneously. Alternatively, controller 302 will have at least some period of time when not all of radiation source(s) 102 are powered on simultaneously. If controller 302 does not keep at least some of radiation source(s) 102 (although not necessarily the same radiation source(s) 102) off all of the time, nearly all of the time, most of the time, or at least some of the time, the current required for operation may be very high and may generate excess heat in addition to requiring a very large power source as compared to the current required, the heat generated, and the size of the power source when some or all radiation source(s) 102 are turned on and off to conserve power. A large power source and excessive heat dissipation requirements may require component sizes that limit the portability of a radiation applicator and the ease and/or comfort with which radiation applicator can be Worn. The selective activation of radiation source(s) 102 and the duration of radiation source activation time (e.g., the duty cycle) may be based upon the power capacity of a power source, which is kept small enough to keep radiation applicator portable and self-contained. Alternatively, or in addition, the amount of time that a given one of radiation source(s) 102 is kept on may be based upon cooling considerations and/or a desired intensity of radiation that is expected to be therapeutic. In an alternative embodiment, radiation applicator 100 is connected to an external computer or an external controller during, before, or after operation or is at least in part controlled wirelessly by a remote unit during, before, or after treatment. Additionally, as will be appreciated, the power source may be contained in a water-resistant, or water-proof, housing (not shown). The housing may be configured to be connectable to the radiation applicator 100 in such a manner that the connectors between the radiation applicator 100 and the housing can be connected in a manner that provides a secure moisture resistant connection.

Using a microcontroller for controller 302 may simplify the structure of the radiation applicator as well. For example, in an embodiment in which each of radiation source(s) (e.g. 102a) is on for only a short period of time before being turned off and another one of radiations sources (102n) being turned on, heat transfer through substrate 104 is not as large an issue as it would be if all of radiation source(s) 102 (e.g. 102a-102n) were run continuously. Consequently, there may not be any need to pump a fluid through radiation applicator 100 for cooling. Similarly, there may not be any need for perforating substrate 104 for cooling.

Optionally, radiation applicator 100 may include one or more detectors to detect whether the body surface of the patient has been harmed and/or may be harmed soon. For example, radiation applicator 100 may include one or more detectors to detect erythema. The detectors may detect erythema by detecting the color of a target portion of the body (e.g., skin color). In another embodiment, there may be detectors for detecting the color, moisture, and/or temperature of the target portion being irradiated to ensure that the portion irradiated is not being damaged by the radiation. Optionally, after detecting erythema and/or any other condition indicative that radiation applicator 100 may have harmed, or may harm, the target portion being irradiated, controller 302 may automatically turn off radiation source(s) 102 (e.g. 102a-102n). Controller 302 may turn off the radiation source(s) 102 associated with the erythemal region as part of the calibration routine and/or as a safety feature during a treatment in response to input from one or more detectors concerning the condition of the region being irradiated (e.g., after an erythemal condition is detected).

Although FIG. 3 shows an example in which there is only one controller 302, there may be a plurality of controllers. Each one of radiation of sources 102 or each group of radiation source(s) 102 may have its own controller. There may be a system of controllers in which there is one master controller that controls other local controllers, and the local controllers may control individual ones of and/or groups of radiation source(s) 102. Optionally, controller 302 may have one or more input ports or input devices that may be used for programming, inputing parameters, and/or setting controller 302 according to a particular therapy, which may be based on a calibration that was performed. The programming, input parameters, and/or settings may be entered by a patient, entered by a doctor, and/or automatically entered as part of a calibration and/or setup procedure. Examples of inputs include, but are not limited to, Bluetooth®, USB, optical, or any other wired or wireless connections

Power source 304 powers controller 302 and/or radiation source(s) 102a re provided for as shown in FIG. 3 In the example of FIG. 3, power source 304 supplies power to radiation source(s) 102 via controller 302. Power source 304 may be one or more batteries, a power supply that plugs into an outlet, and/or one or more photocells for recharging one or more batteries. Power source 304 may include one or more flat, disc-shaped batteries, which may be less than 2 or 3 millimeters thick, and less than 1 or 2 centimeters in diameter. For example, power source 304 may be one or more lithium ion batteries. Alternatively, power source 304 may be one or more nickel cadmium, AA, and/or AAA batteries, for example. Although in the example of FIG. 3 there is only one power source shown, there may be a plurality of power sources located in a plurality of locations within radiation applicator 100. Each one of, or each group of, radiation source(s) 102 (e.g. 102a-102n) may have their own power source. Power source 304 may be located on substrate 104. In an embodiment, power source 304 is an integral part of substrate 104 (e.g., power source 304 may be embedded with substrate 104). In another embodiment, power source 304 is one or more photovoltaic cells.

Depending upon the configuration of the radiation applicator 100, the weight of the device can range from, for example, 0.5 g to 200 g, more preferably from 0.5 g to 100 g, and even more preferably from 0.5 g to 10 g. As will be appreciated by those skilled in the art, these weight ranges are meant to be illustrative of a reasonable weight which an individual can tolerate. Other weight ranges could be used without departing from the scope of the invention.

Electrical connections 306 communicatively connect radiation source(s) 102 (e.g. 102a-102n) to cotroller 302 so that controller 302 is capable of controlling radiation source(s) 102. Electrical connections 306 also electrically connect power source 304 to radiation source(s) 102, via controller 302, such that power source 304 supplies power to radiation source(s) 102. Electrical connections 306 may include a bus that sends signals to individual radiation source(s) 102. Alternatively, electrical connections 306 may include individual pairs of electrical connections, where each pair links one of, or one group of, radiation source(s) 102 directly to controller 302.

Electrical connections 306 may be attached to substrate 104 individually or they may be created directly on the material by a process of photolithography. Alternatively, electrical connections 306 are embedded in a flexible insulating film, the entire film then being attached to substrate 104.

FIG. 4 shows a block diagram of an example of controller 302. Controller 302 may include processor 402, memory 404, and signal generator 405. Memory 404 may have a therapy program 406, calibration program 408, and/or other programs 410. Memory 404 may store MED 412 and/or other parameters such as the dose history previously applied to the patient. Controller 302 may also include one or more input ports 414 and one or more output ports 416. In other embodiments, controller 302 may not have all of the components associated with FIG. 4 and/or may have other components in addition to or instead of those associated with FIG. 4.

Processor 402 performs the therapy program and/or calibration programs referred to above and/or other programs. Memory 404 may include one or more machine-readable mediums that may store a variety of different types of information.

The term machine-readable medium is used to refer to any medium capable of carrying information that is readable by a machine, such as processor 402. One example of a machine-readable medium is a computer-readable medium. Although machine-readable medium of memory 404 is capable of storing information for a period of time that is longer than the time required for transferring information through memory 404, the term machine-readable medium may also include mediums that carry information while the information that is in transit from one location to another, such as copper wire and/or optical fiber.

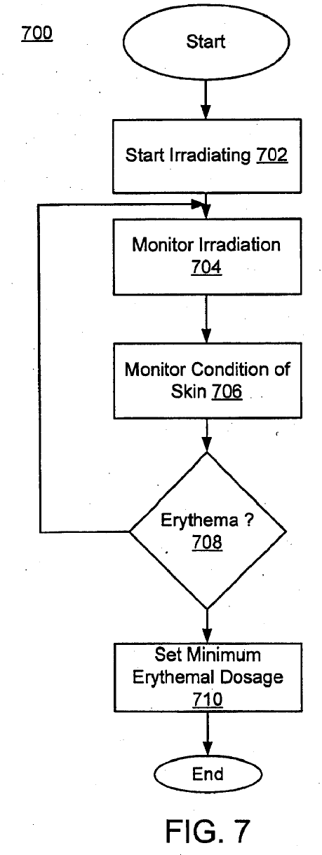

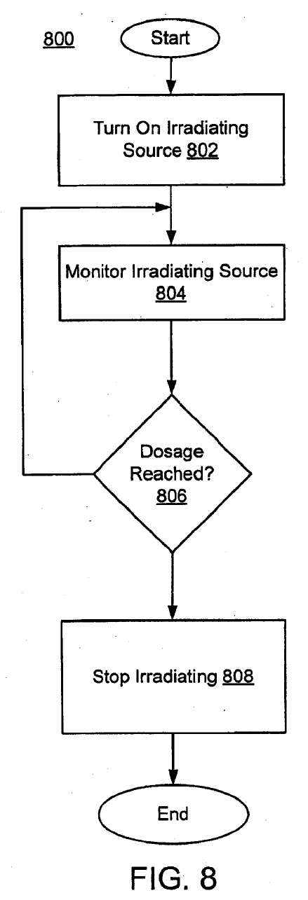

Memory 404 stores programs that are executed by processor 402 and/or parameters used by those programs. In this specification, the word program is used to refer to any group of one or more instructions that cause a processor to perform at least part of a task when the one or more instructions are executed. In the example of FIG. 4, memory 404 may store therapy program 406 and/or calibration program 408 and or dose history program. Therapy program 406 and calibration program 408 include one or more instructions that cause processor 402 to perform the therapy and the calibration discussed in conjunction with FIGS. 1-3, respectively. Memory 404 may also store other programs 410, which are optional. If present, other programs 410 may include one or more other programs entered by the doctor or patient. Therapy program 406 will be discussed further in conjunction with FIG. 8, and calibration program 408 will be discussed further in conjunction with FIG. 7.

MED 412 (such as discussed in conjunction with FIG. 3) and/or other parameters may be entered by a patient or doctor and/or may be determined and/or stored automatically. One or more input ports 414 may be connected to one or more input devices for entering programs and/or parameters into memory 404. One or more input ports 414 may also receive input from one or more detectors used for calibrating radiation applicator 100. One or more input ports 414 may be useable as an interface to a computer or other machine that is used for programming controller 302. One or more input ports 414 may be useable for downloading programs, an MED, configuration parameters, and/or other information to controller 302. Input ports 414 may include an input port for a wireless signal (e.g., an antenna). Alternatively, a computer or other machine may be attached to one or more input ports 414, and used to either directly control radiations sources 102 or control radiation source(s) 102 via controller 302.

Signal generator 415 may produce a variety of different signals that vary in pulse width, pulse height, and/or pulse shape. Signal generator 415 may produce signals having different duty cycles based on the capabilities of power source 304, and based on how much heat is generated by radiation source(s) 102 (e.g. 102a-102n) while in an on state and/or a desired therapy. Signal generator 415 may be controlled by processor 402. Signal generator 415 is optional. In an embodiment in which signal generator 415 is not present, processor 402 may address radiation source(s) 102 directly.

One or more output ports 416 may be associated with the controller 302 and may be connected, via electrical connections 306, to radiation source(s) 102. There may be one output port 416 for each one of, or each group of, radiation source(s) 102. One or more output ports 416 may be capable of being connected to one or more output devices, such as a monitor and/or display. By connecting an output device, it may be possible to view programs and/or parameters entered into memory 404 to aid in programming processor 402 and/or debugging one of the programs stored on memory 404. If signal generator 415 is present, some of the one or more output ports 416 may be connected to corresponding outputs of signal generator 415, and some of the one or more output ports 406 may be connected directly to processor 402 for communicating with an external device, such as a computer or terminal.

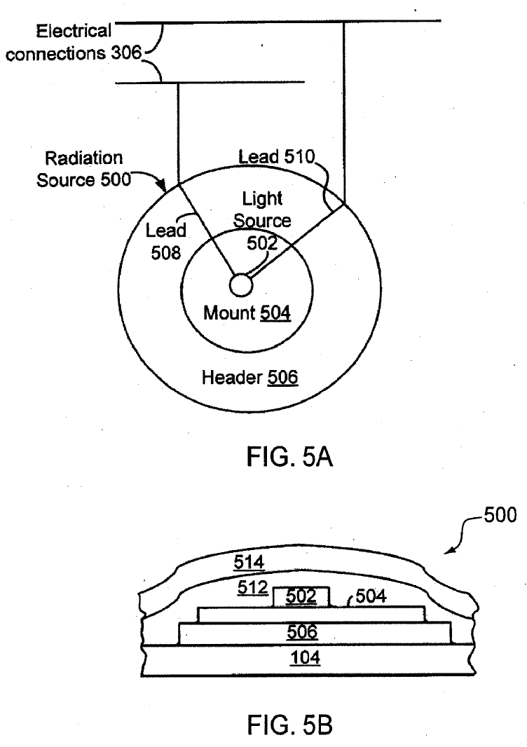

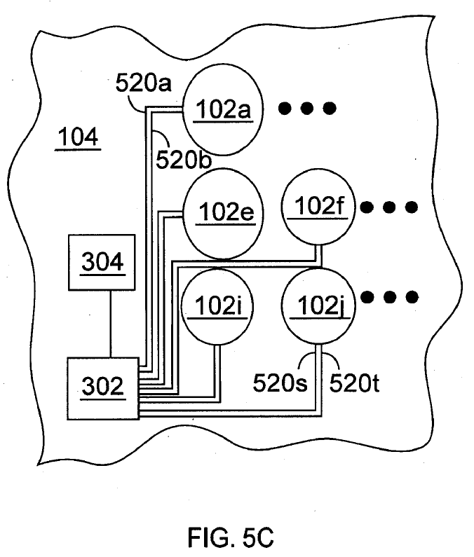

FIG. 5A shows a schematic diagram of an example of radiation source 500. Radiation source 500 may include the actual radiation source 502, such as a light source, and its supporting elements which allow the radiation source to function. For example, if the radiation source is a light emitting diode (LED), the supporting elements will include mount 504, header 506, lead 508, and lead 510. In other embodiments, radiation source 500 may not have all of the components associated with FIG. 5A and/or may have other components in addition to, or instead of, those associated with FIG. 5A.

Radiation source 502 may be a surface mount LED, or LED die, such as a UV LED, blue light LED, white light surface mount (SMD), or UV LED die. As another example, radiation source 502 may be a small light bulb, resistive heater, or a device for generating microwaves, x-rays, and/or radio frequency light. More specifically, radiation source 502 can emit energy in the immunosuppressive range of the ultraviolet spectrum. Wavelengths included in the immunosuppressive range of the ultraviolet spectrum include those from 295 nm to 320 nm and/or from 340 nm to 400 nm. In other embodiments where it is desired to treat infectious agents, radiation source 502 can emit ultraviolet light in the range 250-300 nm.

In an embodiment where radiation source 502 is a light source, mount 504 may hold light source 502 in place. Mount 504 may include a heat sink, circuit board, or a circuit board on top of a heat sink (e.g., a passive heat sink to diffuse heat over a larger surface area or an active sink to electrically pump heat away from the light generating regions). One example of a circuit board (sub-mount) is a gold-patterned ceramic such as beryllium-oxide (BeO) or aluminum nitride (AIN); the ceramic can act as a heat sink or a highly conducting heat transfer element through which heat conducts to the heat sink. Mount 504 may be a material such as Covar alloy, composed of Nickel-Iron, which can act as a heat sink in addition to the ceramic material and is a very good material to bond beryllium oxide or aluminum nitride to because it (Cover alloy) has a very similar coefficient of heat expansion. If mount 504 includes a heat sink, mount 504 may reduce the likelihood of light source 502 overheating and/or may otherwise extend the lifetime of light source 502 so that light source 502 lasts longer with a higher optical output per electrical input (efficiency) than were there no heat sink. Although in the example of FIG. 5, there is only one light source 502 on mount 504, there may be plurality of light sources on each mount 504. Light source 502 (e.g., an individual or multitude of UV LEDs) may be attached (e.g., bonded) to mount 504 using a eutectic metal or a solder. Optionally, mount 504 may be textured (e.g., roughened) for scattering light or polished for specularly reflecting light. Mount 504 may be shaped for concentrating, diffusing, collimating, or dispersing light form light sources 502. Mount 504 may be flat, concave, or convex. If mount 504 is concave or convex, mount 504 may be elliptical, spherical, or hyperbolic, for example. Mount 504 may be composed of, or coated with, a reflecting metal such as aluminum or aluminum derivative.

Header 506 may protect light source 502 and mount 504 from being separated. Although in the example of FIG. 5, header 506 has only one mount 504, there may be plurality of mounts 504 and each mount may have only one light source or may have a plurality of light sources. Similar to mount 504, header 506 may be shaped for concentrating, diffusing, collimating, dispersing, or otherwise reflecting light (e.g., with an aluminum reflecting layer) light from light sources 502. Header 506 may be flat, concave, or convex. If header 506 is concave or convex, header 506 may be elliptical, spherical, or hyperbolic, for example. Alternatively, there may be another optical component in addition to, or instead of, shaping and/or texturing mount 504 and/or packaging 506 to have particular optical properties. Specifically, this additional optical component may be shaped for concentrating, diffusing, collimating, or dispersing light from light sources 502. The additional optical component may be flat, concave (for dispersing the radiation), or convex for concentrating the radiation). If the additional optical component is concave or convex, the additional optical component may be elliptical, spherical, or hyperbolic, for example.

In an embodiment, mount 504 and header 506 are separate components that are attached to one another. In another embodiment, mount 504 and packaging 506 may be two parts of the same component and/or only one of mount 504 and packaging 506 are used. If there is more than one light source on each mount 504 and/or within each package 506, the light sources may all have the same spectrum and/or may be associated with the same peak wavelength. Alternatively, there may be different light sources having different spectrums and/or peak wavelengths that are located on the same mount 504 and/or one the same header 506.

Leads 508, 510 supply power to light source 502 for activating light source 502 and keeping light source 502 lit. Leads 508 and 510 may be connected to larger leads on substrate 104 that bring electricity to radiation source 500 (e.g., leads 508 and 510 may be connected to electrical connections 306). Leads 510 and 508 may be made from a eutectic metal placed on or bonded to mount 504. Thus, current from power source 304 flows to controller 302, through electrical connections 306, and to one or more of radiation source(s) 102 (e.g., to leads 508 and 510, and then to light source 502, such as an UV LED), resulting in light, such as UV light, being output.

FIG. 5B shows a cross-section of an embodiment of radiation applicator 100. The embodiment of FIG. 5B includes substrate 104, light source 502, mount 504, header 506, spectral conditioner 512, and optional patient interface 514. In other embodiments, radiation applicator 100 may not have all of the components associated with FIG. 5B and/or may have other components in addition to, or instead of, those associated with FIG. 5B.

Substrate 104 is discussed above in conjunction with FIG. 1 and elsewhere. Light source 502, mount 504, and header 506 are discussed above in conjunction with FIG. 5. Spectral conditioner 512 covers and may protect light source 502 from damage and/or may condition the radiation in one or more ways before it reaches the lesion. Spectral conditioner 512 may be one continuous layer of material that extends over all of region 106 or over all of substrate 104. Alternatively, spectral conditioner 512 may be a collection of patches of material, where each patch conditions the radiation from at least one light source, such as light source 502. In this embodiment, when the spectral conditioner 512 is a patch and individually covers one light source, the entire light source, including the covering 512, header 506, and mount 504 can be individually removed from the material 104 and then replaced on material 104. Depending on the embodiment, spectral conditioner 512 may cover a larger area than light source 502 but smaller than or equal to mount 504, cover a larger area than mount 504 but smaller than or equal to header 506, or cover a larger area than header 506 but not large enough to reach a covering of an adjacent radiation source.

Spectral conditioner 512 may make radiation applicator 100 more comfortable to wear, because the surface of spectral conditioner 512 that contacts the body portion can be smoother than the surface of radiation applicator 100 than if spectral conditioner 512 were not present. Spectral conditioner 512 and substrate 104 may form two layers of material, with light sources 102 sandwiched in between. Spectral conditioner 512 may be a layer of material, which may be transparent or translucent (e.g. to ultraviolet light between 250 nm and 320 nm), while a substrate 104 may be transparent, opaque, translucent, or reflective. If substrate 104 is reflective, substrate 104 may be specularly reflective or may scatter light. By making substrate 104 reflective, the efficiency of radiation applicator 100 is improved as compared to where substrate 104 is not reflective. By making either or both of substrate 104 and covering 512 a light scattering material, the uniformity of the irradiation may be improved as compared to if substrate 104 and/or spectral conditioner 512 do not scatter light. Spectral conditioner 512 may be made to scatter light using any of the structures discussed above in conjunction with the discussion of substrate 104 of FIG. 2. Spectral conditioner 512 may reduce efficiency (depending upon how much radiation it absorbs or otherwise prevents for reaching the patient), but may improve the uniformity of the irradiation and/or comfort to the patient.

Optional patient interface 514 may be an adhesive to help radiation applicator 100 adhere to the body portion being treated. Optional patient interface 514 may be a layer of adhesive material (e.g., glue) that covers one surface of, or of one surface of, radiation applicator 100, such as covering 512. Optional adhesive 514 may be included in an embodiment in which radiation applicator 100 is a bandage that sticks to a portion of skin of a patient, for example. Optional adhesive 514 may the adhesive discussed in conjunction with FIG. 1 and/or substrate 104. In addition to glue, patient interface 514 may incorporate therapeutic substances designed to prevent damage and/or enhance the therapeutic efficacy of the radiation delivered by radiation applicator 100. Examples of potentially protective compounds include titanium oxide, zinc oxide, and others well-known to those skilled in the art. Examples of compounds to improve efficacy can include photosensitizers such as psoralens, photoporphyrins, and other photosensitizers which are well-known in the art. FIG. 5C shows a bock diagram of an example of an embodiment of radiation applicator 100. FIG. 5 includes radiations sources 102a, 102b, 102e, 102f, 102i, and 102j, substrate 104, controller 302, power source 304, and electrical connections 520 (such as 520a- 520s). In other embodiments, radiation applicator 100 may not have all of the components associated with FIG. 5C and/or may have other components in addition to or instead of those associated with FIG. 5C.

Radiation source(s) 102a, 102e, 102f, 102i, and 102j are specific ones of, or specific groups of, radiation source(s) 102 (e.g. 102a-102n), which are discussed in conjunction with FIGS. 1 and 5A shown in FIG. 5C. The sets of three dots after radiation source(s) 102a, 102f, and 102j represent any number of radiations sources. Although pairs of letters, such as “e” and “f,” and “i” and “j,” may represent pairs of consecutive numbers that are smaller than the number represented by “n,” there may be any number of radiation source(s) between radiation source(s) 102b and 102e, between radiation source(s) 102f and 102i, and between radiation source(s) 102j and 102n. Substrate 104 is discussed in conjunction with FIGS. 1 and 5B and elsewhere. Controller 302 and power source 304 are discussed in conjunction with FIG. 3 and elsewhere.

Electrical connections 520 (e.g. 520a-520s) are paired with one another. Each pair completes a circuit between controller 302 and one of radiation source(s) 102 (e.g.102a-102n). The pattern of electrical connections 520a-520n is different than electrical connections 306 (FIG. 3). In this embodiment, each radiation source or group of radiation source(s) has its own ground or return electrode and can be controlled independently by controller 302.

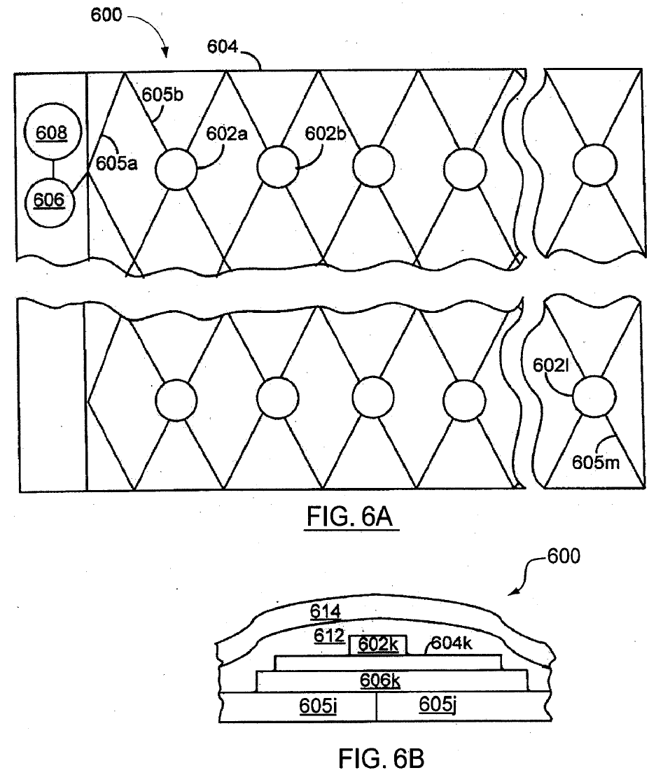

FIG. 6A shows a radiation applicator 600. Radiation applicator 600 includes radiation source(s) 602a-l, substrate 604 having cords 605a-605m, controller 606, and power source 608. In other embodiments, radiation applicator 600 may not have all of the components in FIG. 6A or may have other components in addition to, or instead of, those in FIG. 6A.

Radiation applicator 600 may be an embodiment of radiation applicator 100. Radiation source(s) 602a-l could be of any of the types of radiation source(s) as radiation source(s) 102 (e.g. 102a-102n) and/or 500. Substrate 604 may be a mesh (e.g., a flexible net) that is made of crisscrossing cords 605a-m, which may be an embodiment of substrate 104 in FIG. 1. For example, the flexible net that makes up substrate 604 may be a bandage. Radiation source(s) 602a-l can be placed at the intersection of individual cords 605a-m of substrate 604. In an alternative embodiment, radiation source(s) 602a-602l may be placed on other parts of cords 605a-605m in addition to, or instead of, being placed at the intersections of two of cords 605a-605m. Controller 606 may be the same as controller 304, and power source 608 may be the same as power source 304. Cords 605a-m may carry or may include electrical connections 306 and/or optical fibers that bring electricity and/or optical communications from controller 606 to radiation source(s) 602 for powering and/or communicating with radiations sources 602a-6021. The configuration of cords 605a-605m allow radiation source(s) 602a-602l to cool by allowing air to pass across the backs of radiation source(s) 602a-602l. The configuration further allows for flexible spacing between the intersections of the cords In this way, the material (the nodes) can be spread apart by applying force to the edges of the radiation applicator 600 and then allowed to return to the prior spacing when the edges are allowed to return their previous spacing. Although the embodiment of FIG. 6A does not include a region such as region 106, in an alternative embodiment, substrate 604 may include a region 106.

FIG. 6B shows a cross-section of an example of an embodiment of a radiation applicator 600. The embodiment of FIG. 6B includes light source 602k, mount 604k, cord 605i, cord 605j, header 606k, spectral conditioner 612, and optional patient interface 614. In other embodiments, radiation applicator 600 may not have all of the components associated with FIG. 6B and/or may have other components in addition to, or instead of, those associated with FIG. 6B.

Light source 602k, mount 604k, and header 606k are the light source, mount, and header of one of radiations sources 602a-602n. Light source 602k, mount 604k, and header 606k may be embodiments of light source 502, mount 504, and header 506, respectively. Similarly, spectral conditioner 612 and optional patient interface 614, which may include adhesive, may be an embodiment of spectral conditioner 512 and optional patient interface 514, respectively. Cords 605i and 605j are two of cords 605a-605l. Cords 605i and 605j are a pair of cords that crisscross one another under mount 604k.

### EXAMPLE 1

A U LED (310 nm) chips from S-ET (Columbia, S.C.) were used as one radiation (light in this case) source 102a; the chip was mounted on a gold patterned aluminum nitride sub-mount and further mounted on a Covar header. The patterning was performed by Advanced Thin Film in Fremont, Calif. The chips were bonded to a eutectic metal layer (e.g. gold-tin alloy) which was deposited on parts of the gold portions of a sub-mount and then to a TO-46 (well-known to those skilled in the art) header package. An aluminum reflector was attached with epoxy to the header which serves to reflect the light toward the spectral conditioner (e.g. a lens in this case). In this example, a patient interface was not included in the assembly. The radiation applicator was then applied to the skin for approximately 14 minutes. A 14 minutes, the dose was sufficient to sunburn a region of one square centimeter (the region had previously been assessed to require 350 mJ/cm² for an MED at 310 nm). The required voltage was approximately 4.5 Volts and the current approximately 35 milliamps; the required optical power was therefore 340 microwatts per cm² which translates to 150-200 milliWatts of electrical power. A collection of portable alkaline batteries (AA) was used for this experiment. However, many different battery sources can be utilized. Any power supply can be used which generates the appropriate currents. As discussed above, the power supply only need generate 5-100 mA because only certain ones or groups of LEDs are turned on at a given time. Many common types of power sources can be used for this power regime. For example, batteries such as AA, AAA, B, C, D, 9V, Lithium, Lithium Ion, Zin-Carbon, Alkaline batteries, rechargeable alkaline batteries, Nickel-Cadmium batteries, Nickel0Metal Hydride batteries, Nickel, Iron batteries, Nickel-Zinc Fuel cell batteries, polymer batteries, photovoltaic batteries, or any other batteries available, Thus, a radiation applicator produced from these LED chips could include many of these devices wired on a substrate. A region such as a 0.5% body surface area (approximately 50 cm²) could be radiated with 50 chips (for example) and utilize 7-10 watts of power over 15 minutes. 5-10 Watts of power could be contained in a portable battery pack and when spread over 50 square centimeters, the generated heat would be dissipated without a large increase in temperature.

### EXAMPLE 2

In another example, a radiation applicator was made using the materials and techniques described with respect to Example 1. However, a UV LED submount containing four LEDs was used for radiation source(s) 102 (e.g. 102a-102n) instead of the UV LED chips. This alternate radiation source 102 resulted in a sunburn over an area of 2 cm² in approximately 3.5 minutes with a voltage of approximately 6 Volts and using 80 milliamps of current.

In applying the device of Example 2 to, for example, psoriasis, which has an average size of a diseased area of approximately 100 cm² (approximately 1% of the body surface area of a patient), is capable of giving a patient a sunburn over a 100 cm² area by applying a therapeutic dose via the 2 cm² sized radiation applicators to 50 2 cm² patches, one patch at a time, each for 3.5 minutes. Radiation applicator 100 is capable of delivering a therapeutic dose of ultraviolet light to these 50 patches, in approximately 50×3.5 minutes=175 minutes, or three hours. This therapy is made possible by controller 302, which directs current to the individual packaged LEDs and ensures that each area of skin receives a therapeutic dose but not more than the therapeutic dose of radiation therapy. In this example, the output from the battery source is approximately 0.5 to 1.0 Watts which is easily accommodated by any of the power sources mentioned above or by a photovoltaic source.

In another embodiment, radiation applicator 100 is constructed from 50 or more radiation applicators 100 of the second example or from one radiation applicator 100 that is similar to that of the second example but 50 times larger. Consequently, either of these larger versions could treat an average sized psoriasis patch of skin in less than 175 minutes (e.g., 3.5 minutes).

FIG. 7 shows a flowchart of an example of a method 700 for calibrating radiation applicator 100 for a particular patient. Method 700 may be an embodiment of program 408. In step 702, system 700 begins to irradiate a target portion of a body that is not affected by the disease being treated. Step 702 may include placing batteries in power source 304 and turning on system 304. Step 702 may also include entering a command into controller 302 that places radiation applicator 100 in a calibration mode and/or turns on radiation applicator 100. In step 704, the irradiation is monitored by keeping track of how long the target portion being irradiated has been irradiated and/or how much radiation is being sent to the target portion. Step 704 may be implemented by timing how long each of the radiation source(s) 102 (e.g. 102a-102n) have been kept on and/or by actually measuring samples of the output from radiation applicator 100. In step 706, the condition of the portion being irradiated is monitored. The monitoring may be performed by a detector or by a human being periodically checking the condition of the target portion being irradiated. Step 702, 704, and 706 may be initiated in any order. The actual monitoring of the condition of the target portion is performed while irradiating the target portion or by interrupting the irradiation.

In step 708, based on the monitoring of step 706, a decision is made as to whether the portion being irradiated has received an erythemal dose. In an embodiment, during step 708, the first detectable point when the portion being irradiated has received an erythemal dose triggers a decision that an erythemal dose was reached. If an erythemal dose has not been received, steps 702, 704, and 706 are allowed to continue to be performed. If an erythemal dose has been received, method 700 proceeds to step 710. Steps 702, 704, 706, and 708 may be implemented by applying escalating doses of radiation over a specific period of time (e.g., 24 hours). After each period of time, if erythema is not reached, the period of time is started over again, but the dose of radiation delivered is escalated (e.g., increased) to a higher amount. If after a given period, erythema is reached, the method proceeds to step 710. In step 710, the MED is determined, and radiation applicator 100 is configured so that when used in the future, radiation applicator 100 will deliver a MED or a somewhat lower dosage; in any case, the MED acts as an internal calibration for each patient's skin type. In some therapeutic regimens, multiples of the MED is required or fractions of the MED may be required for therapy. The MED is determined by comparing the results of steps 704 and 706. The MED may be expressed as a period of time for running radiation applicator 100 and optionally by recording information about the duty cycle used. Alternatively, the total amount of time that each individual one of radiation source(s) 102 (e.g. 102a- 102n) was left on is recorded. Step 710 may be just recording the MED on paper or may be entering the MED into memory 404, entering a setting into controller 302 that determines either how long radiation applicator 100 stays powered on before controller 302 shuts off radiation applicator 100 or the total time that any one of radiation source(s) 102 (e.g. 102a-102n) is allowed to be on.

FIG. 8 shows a flowchart of an example of a method 800 of using radiation applicator 100. Method 800 may be an embodiment of program 406. In step 802, radiation applicator 100 is turned on, and radiation applicator 100 irradiates a portion of a target portion of a body. Step 802 may include sending current via electrical connections 306 from power source 304 to controller 302. Step 802 may include processor 402 running program 406, which causes signal generator 405 to generate signals. Step 802 may also include controller 302 sending the generated signals via electrical connections 306, thereby turning on some of radiation source(s) 102 while turning off others of radiation source(s) 102 according to a cycle that is based on a maximum amount of power that power source 304 can support. In step 804, the irradiation is monitored. Step 804 may include timing how long radiation applicator 100 has been on and/or turning how long each radiation source(s) 102 and/or each group of radiation source(s) 102 have been on. Alternatively, step 804 may involve sampling and measuring some of the output of radiation applicator 100 and/or the condition of the target portion in addition to, or instead of, timing how long radiation applicator 100 has been on. In step 806, a determination is made as to whether a prescribed dose has been received and/or delivered. If a prescribed dose has not been received or delivered, steps 802 and 804 are allowed to continue. If a prescribed dose has been received or delivered, then method 800 continues to step 808, where radiation applicator 100 the irradiation of the target portion is terminated. Since different radiation source(s) 102 (e.g. 102a-102n) are on at different times, different ones of radiation source(s) 102 (e.g. 102a-102n) deliver the prescribed dose at different times. Consequently, step 808 may involve selectively turning off individual ones of, or groups of, radiation source(s) 102 that have delivered the prescribed dose or that are over areas where the prescribed dose has been received. After step 808, method 800 terminates. Method 800 may be implemented by turning on radiation applicator 100, by setting a timer that shuts down each of radiation source(s) 102 of radiation applicator 100 after a period of time has elapsed during which it is expected that the radiation source has delivered a dose as determined by the patient or medical practitioner.

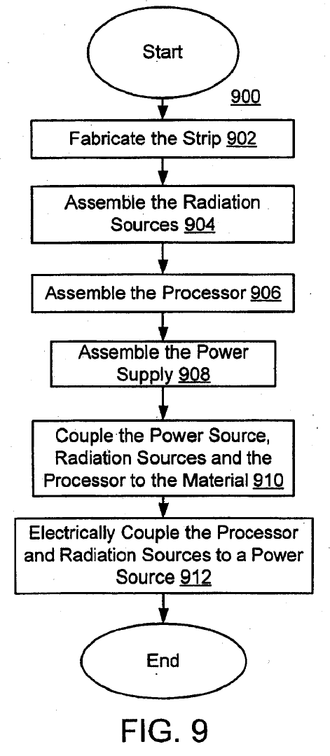

FIG. 9 is a flowchart of a method 900 of assembling radiation applicator 100. During step 902, radiation source(s) 102 are assembled. During step 904, substrate 104 is fabricated. During step 906, controller 302.is assembled. During step 908, power source 304 is assembled. During step 910, radiation source(s) 102, controller 302, and power source 304 are coupled to substrate 104. Step 910 may include attaching radiation source(s) 102, controller 302, and power source 304 to region 106. During step 912, controller 302 and radiation source(s) 102 are communicatively coupled to one another. For example, connections 306 are placed on substrate 104 and connected to controller 302, power source 304, and radiation source(s) 102. Steps 902, 904, 906, and 908 may be performed simultaneously or in any order with respect to one another. Similarly, steps 910 and 912 may be performed simultaneously or in any order with respect to one another.

A variety of kits are also contemplated for use with this invention. For example, patients could be provided with kits that have a plurality of radiation applicators with different sizes and shapes and in which each size and shape can be fit together. The applicators could be configured to provide the same radiation for the same amount of time, or could be applicators having different radiation types and/or amounts and/or time configurations. The applicators can be fit together and then further adapted to communicate with a computer program to customize the type, quality, quantity and/or location of treatment to a pre-defined region. For example, where it would be desirable to provide a first quality of treatment at a first time and a second quality of treatment at a second time, or where it is anticipated that the amount of radiation and/or time of radiation required would change during the course of delivering the therapy. Thus, for example, a first radiation applicator having the ability to deliver a first amount of radiation at a first amount of time, could be provided with a second radiation applicator having the ability to deliver a second amount of radiation for a second amount of time. Thus enabling a kit to be provided that has the ability to slowly increase therapy over time, increase and then decrease therapy over time, or decrease therapy over time.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A phototherapeutictreatment apparatus comprising: a plurality of light sources wherein at least one light source is adapted to emit light at a peak wavelength between about 300 nm and about 320 nm; a light source support structure adapted to be worn by a patient and to support the light sources in a manner permitting light from the light sources to reach a skin area of the patient; a controller adapted to operate the light sources; and a power supply adapted to provide power to the light sources.

2. The phototherapeutic treatment apparatus of claim 1 wherein said at least one light source is adapted to emit light at a peak wavelength between between about 308 nm and about 312 nm.

3. The phototherapeutic treatment apparatus of claim 1 wherein said at least one light source is an LED.

4. The phototherapeutic treatment apparatus of claim 1 wherein the support is one of: a mesh; a material shaped to cover a hand; a material a shaped to cover a foot; and a material shaped to circumscribe an extremity.

5. The phototherapeutic treatment apparatus of claim 1 wherein the support is adapted to be attached to the patient's skin.

6. The phototherapeutic treatment apparatus of claim 5 further comprising an adhesive associated with the support.

7. The phototherapeutic treatment apparatus of claim 5 further comprising an elastic covering.

8. The phototherapeutic treatment apparatus of claim 1 wherein the controller is adapted to separately address at least one of the plurality of light sources.

9. The phototherapeutic treatment apparatus of claim 1 wherein the controller is adapted to monitor LED operation time.

10. The phototherapeutic treatment apparatus of claim 1 wherein the power supply is adapted to be worn by the patient.

11. The phototherapeutic treatment apparatus of claim 1 wherein the controller is adapted to regulate the output from the power supply so that each light source provides a minimum erythemal dose to the patient over a period of time ranging from 30 seconds to 48 hours.

12. The phototherapeutic treatment apparatus of claim 1 wherein the power source and each light source is adapted to supply a dose of between about 100 mJ/cm² and about 600 mJ/cm².

13. The phototherapeutic treatment apparatus of claim 1 wherein the power source is rechargeable.

14. A radiation treatment device adapted to delivery radiation therapy to a target body surface comprising:
(a) a substrate adapted to contact a target surface of a human body;
(b) a first radiation source for delivering radiation to the target surface area of the human body and adapted to engage the substrate; and
(c) a controller integrated with the substrate and adapted to control at least one of duration or amount of radiation delivered by the radiation source.

15. The radiation treatment device of claim 14 wherein the substrate is a flexible substrate.

16. The radiation treatment device of claim 14 further comprising a power source.

17. The radiation treatment device of claim 14 wherein the radiation source delivers light to the target surface area.

18. The radiation treatment device of claim 14 further comprising an adhesive layer over at least a part of a first surface of the substrate.

19. The radiation treatment device of claim 14 further adapted to cool the target surface area of the human body while radiation is delivered by the radiation source.

20. The radiation treatment device of claim 14 wherein the device is portable.

21. The radiation treatment device of claim 14 wherein the controller is pre-programmed to deliver radiation in a predetermined on/off sequence.

22. The radiation treatment device of claim 14 wherein the controller is adapted to receive information from a sensor providing information from the target surface area of the human body.

23. The radiation treatment device of claim 22 wherein the controller controls the delivery of radiation to the target surface area of the human body in response to information received from the sensor.

24. The radiation treatment device of claim 16 having a weight of less than 500 g.

25. The radiation treatment device of claim 14 further comprising a cooling device.

26. The radiation treatment device of claim 14 wherein a second radiation source for delivering radiation to the target surface area of the human body is provided.

27. The radiation treatment device of claim 26 wherein the first radiation source delivers radiation for a first time and the second radiation source delivers radiation for a second time.

28. The radiation treatment device of claim 26 wherein the first radiation source delivers radiation for a first amount and the second radiation source delivers radiation for a second amount.

29. The radiation treatment device of claim 14 wherein the first radiation source delivers a first amount of radiation and a second amount of radiation.

30. The radiation treatment device of claim 14 wherein the radiation source is a light source.

31. The radiation treatment device of claim 30 wherein the light source is an LED.

32. The radiation treatment device of claim 16 wherein the power source is adapted to be worn by the patient.

33. The radiation treatment device of claim 16 wherein the power source is adapted to supply one-half to three minimum erythemal doses to the patient from each radiation source over a period of time from 30 seconds to 48 hours.

34. The radiation treatment device of claim 16 wherein the power source and the radiation source is adapted to supply a dose of between about 100 mJ/cm² and about 600 mJ/cm².

35. The radiation treatment device of claim 16 wherein the power source is rechargeable.

36. A method of providing light therapy to a skin area of a patient comprising:
(a) attaching a plurality of light sources to the skin area;
(b) providing power to the light sources from a power supply worn by the patient; and
(c) providing light having a peak wavelength between about 295 nm and about 320 nm from one or more of the light sources to the skin area.

37. The method of providing light therapy to a skin area of a patient of claim 36 wherein the step of providing light comprises providing light having a peak wavelength between about 308 nm and about 312 nm from one or more of the light sources to the skin area.

38. The method of providing light therapy to a skin area of a patient of claim 36 wherein light sources comprise first and second sets of one or more light sources, step of providing light comprises providing light from the first set of light sources and not from the second set of light sources and providing light from the second set of light sources and not from the first set.

39. The method of providing light therapy to a skin area of a patient of claim 38 wherein the step of providing light from the first set of light sources comprises supplying an MED from the first set of light sources over a period of time ranging from 30 seconds to 48 hours.

40. The method of providing light therapy to a skin area of a patient of claim 39 wherein the step of providing light from the second set of light sources comprises supplying about an MED from the second set of light sources over a period of time ranging from 30 seconds to 48 hours.

41. The method of providing light therapy to a skin area of a patient of claim 38 wherein the step of providing light from the first set of light sources comprises supplying an energy dose of between about 100 mJ/cm² and about 600 mJ/cm² from the first set of light sources.

42. The method of providing light therapy to a skin area of a patient of claim 41 wherein the step of providing light from the second set of light sources comprises supplying an energy dose of between about 100 mJ/cm² and about 600 mJ/cm² from the second set of light sources.

43. The method of providing light therapy to a skin area of a patient of claim 36 further comprising the step of monitoring a duration of the step of providing light.

44. The method of providing light therapy to a skin area of a patient of claim 36 further comprising the step of calibrating light source energy delivery to provide a therapeutic dose of energy and programming calibration parameters into a light source controller.

45. The method of providing light therapy to a skin area of a patient of claim 44 wherein the skin area comprises a skin treatment area, and the calibrating step comprises providing a therapeutic dose of energy to a skin test area other than the skin treatment area.

46. The method of providing light therapy to a skin area of a patient of claim 45 wherein the step of providing a therapeutic dose of energy to a skin test area comprises supplying light from one or more light sources to the skin test area for about 24 hours.

47. The method of providing light therapy to a skin area of a patient of claim 45 further comprising monitoring a parameter related to light source energy delivery during the step of providing a therapeutic dose of energy to the skin test area.

48. The method of providing light therapy to a skin area of a patient of claim 45 wherein the therapeutic dose of energy comprises an MED.

49. A method of treating a target surface area of a human body with phototherapy comprising:
(a) defining the extent of the target surface area to be treated with an irradiation device;
(b) applying a radiation treatment device so that the radiation sources irradiate at least a portion of the defined target area of the human body while not irradiating an undefined target area;
(c) monitoring the irradiation dose applied to the target surface area of the human body;
(d) turning off the phototherapy when a prescribed dose is reached.

50. A method of calibrating a target surface area of a human body comprising:
(a) applying a radiation treatment device to the target area of the human body;
(b) monitoring a condition of the target surface area of the human body;
(c) assessing whether erythema is present; and
(d) setting a minimum erythemal dosage for the radiation treatment device.

51. A method of treating a target surface area of a human body comprising:
(a) applying a radiation treatment device having a substrate adapted to contact a target surface of a human body, a first radiation source for delivering radiation to the target surface area of the human body and adapted to engage the substrate, and a controller integrated with the substrate and adapted to control at least one of duration or amount of radiation delivered by the radiation source, to the target area of the human body; and
(b) monitoring the irradiation of the target surface area of the human body.

52. The method of treating a target surface area of a human body wherein the step of monitoring comprises at least one of (a) monitoring an irradiation of the target surface area; (b) monitoring a condition of the target surface area; (c) assessing whether erythema is present; and (d) determining whether a programmed erythema dosage has been reached.

53. A kit for treating a target area of a human body needing therapy comprising:
(a) a first radiation treatment device having a substrate adapted to contact a target surface of a human body, a radiation source for delivering radiation to the target surface area of the human body and adapted to engage the substrate, and a controller adapted to control at least one of duration or amount of radiation delivered by the radiation source; and
(b) a second radiation treatment device having a substrate adapted to contact a target surface of a human body, a radiation source for delivering radiation to the target surface area of the human body and adapted to engage the substrate, and a controller adapted to control at least one of duration or amount of radiation delivered by the radiation source.
